(19) United States
(12) Patent Application Publication
(10) Pub. No.: US 2024/0022206 A1
(43) Pub. Date: Jan. 18, 2024

(54) Solar Panel Shapes, Configurations, and Methods of Installing and Positioning Solar Panels

(71) Applicant: Jing-Yau Chung, Houston, TX (US)

(72) Inventor: Jing-Yau Chung, Houston, TX (US)

(21) Appl. No.: 18/353,746

(22) Filed: Jul. 17, 2023

Related U.S. Application Data
(60) Provisional application No. 63/389,665, filed on Jul. 15, 2022.

(51) Int. Cl. H02S 20/32

(52) U.S. Cl. CPC H02S 20/32

(57) ABSTRACT

A solar panel or a plurality of solar panels may each have a length and a cross-section, wherein the solar panel cylinder has an elliptically-shaped cross-section, wherein the elliptically-shaped cross-section is defined by an equation xⁿ/aⁿ+yⁿ/bⁿ=1, wherein the value of n is greater than or equal to 2, and wherein a and b are any positive numbers. The solar panels may also be planar with a plurality of solar panels mounted to a frame, having the frame mounted vertically to a vertical rod, and turning the rotatable rod about an axis. In another aspect of this technology a methodology of installing and positioning solar panels is implemented for maximizing the number of panels to be installed on and above a given ground area, and/or positioning for peak electrical output.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Technical Field: The technical field is directed to solar panel shapes, configurations, and the installation and positioning of solar panels.

### SUMMARY

A solar panel or a plurality of solar panels may each have a length and a cross-section, wherein the solar panel cylinder has an elliptically-shaped cross-section, wherein the elliptically-shaped cross-section is defined by an equation xⁿ/aⁿ+yⁿ/bⁿ=1, wherein the value of n is greater than or equal to 2, and wherein a and b are any positive numbers. The solar panels may also be planar with a plurality of solar panels mounted to a frame, having the frame mounted vertically to a vertical rod, and turning the rotatable rod about an axis. In another aspect of this technology a methodology of installing and positioning solar panels is implemented for maximizing the number of panels to be installed on and above a given ground area, and/or positioning for peak electrical output.

### BRIEF DESCRIPTION OF DRAWINGS

The embodiments may be better understood, and numerous objects, features, and advantages made apparent to those skilled in the art by referencing the accompanying drawings. These drawings are used to illustrate only typical embodiments of this invention, and are not to be considered limiting of its scope, for the invention may admit to other equally effective embodiments. The figures are not necessarily to scale and certain features and certain views of the figures may be shown exaggerated in scale or in schematic in the interest of clarity and conciseness.

FIG. 1 depicts a perspective view of an exemplary embodiment of a solar panel mounting configuration.

FIG. 2 depicts a perspective view of another exemplary embodiment of a solar panel mounting configuration.

FIG. 3 depicts a general top, or a general elevational, schematic view of another exemplary embodiment of a solar panel mounting configuration on a rotating carousel.

### DETAILED DESCRIPTION OF THE PREFERRED EMBODIMENTS OF THE INVENTION(S)

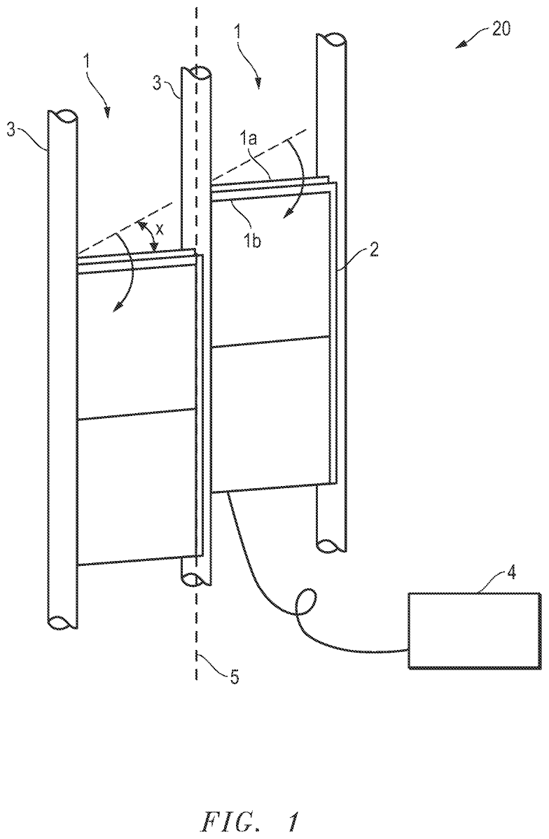

FIG. 1 depicts an embodiment of a solar panel mounting configuration 20. With reference to FIG. 1, a plurality of solar panels 1 is shown. Solar panel 1a is mounted back-to-back with another solar panel 1b and then mounted in frame 2. Frame 2 and a number of frames identical or similar to frame 2 are mounted vertically on rod 3 as depicted in FIG. 1. Rod 3 can be rotated about an axis 5 up to 360°. A meter 4 is used to determine the electrical power output from the entire vertical frames or optionally to determine the power output from a single frame among the vertically mounted frames. During operation, rod 3 turns quickly to determine an optimum angle for maximum electrical power generation. When a peak electrical output is detected at a certain turning angle X of rod 3, such turning angle X is chosen to receive maximum electrical output from the panels until another optimum angle is detected and adopted. It should be noted that not all the rods may be set to be at the same turning angle, and there may be instances where all the rods are not set or turned at the same turning angle. Accordingly, each individual rod 3 or solar panel 1 may be controlled independently. A computer may be implemented into the system or may be integral with a component of the system with respect to control features or functions.

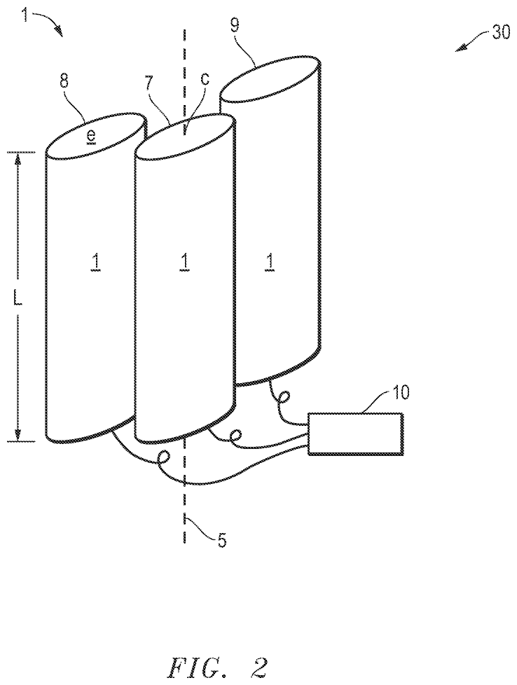

FIG. 2 depicts another embodiment of a solar panel mounting configuration 30 having a plurality of solar panels 1, where elliptical or elliptically-shaped solar panels 7, 8 and 9 for example are shown. Each elliptically-shaped solar panel 7, 8, and 9 is an elliptic cylinder, or in other words, has a length L and an elliptically-shaped ends or cross-section e. It should be noted an elliptically-shaped object is not necessarily a true ellipse. In general, a true ellipse can be expressed mathematically as follows: xⁿ/aⁿ+yⁿ/bⁿ=1, where n is any number equal to or greater than the number 2. When n=2, it represents the equation of an ellipse, and a and b are the major and minor radius respectively. In this equation, the center of the ellipse is at the origin of a Cartesian coordinate with x and y being the horizontal and vertical axes respectively. A circle is a special case of an ellipse, where a=b=1 (and n=2); or the solar panel is a non-elliptical cylindrical panel. It should be noted, however, in the present invention, the shape of elliptically-shaped solar panel 7 is not limited to the case when n=2. Furthermore, the shape of elliptically-shaped solar panel 7 is not limited to those satisfying the above equation either. When n is greater than 2, The shape of elliptically-shaped solar panel 7 for example, is commonly known as a super ellipse.

The elliptically-shaped solar panels 7, 8 and 9 may represent multiple solar panels that can be installed vertically, horizontally or in any other directions. A test meter 10 can be used to collect the total or partial electrical output of the panels in use to determine the time-varying optimum configuration for maximum total electrical output with respect to the panel positioning relative to each other.

In an exemplary embodiment a rod 3 having an axis 5 (akin to FIG. 1) can be mounted through the center c of each the elliptically-shaped solar panels 7, 8 and 9 (and each may be rotated up to 360°).

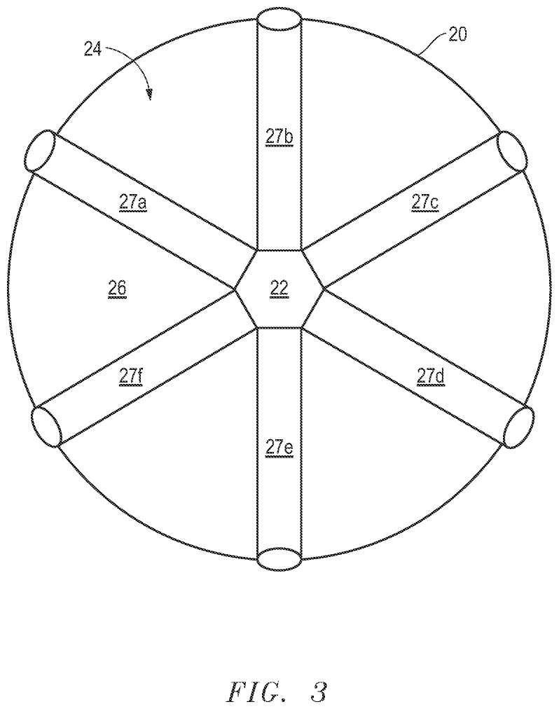

In another exemplary embodiment as represented in FIG. 3, if each end of the respective axes of a group of elliptically-shaped solar panels (in this example 27a-f) are figuratively welded together at a union 22 in a two-dimensional or three-dimensional radial directions of a rotating carousel 20 then the group of the elliptically-shaped solar panels 27a-f in question should be exposed to all light sources coming from any angle in the light sourced three-dimensional space towards the group of the elliptically-shaped solar panels 27-a-f. Such a movable mechanism or rotating carousel 20 is configured and positioned for optimum generation of electricity. In one variation, in the case of a three-dimensional array of elliptically-shaped solar panels, there may be no need to rotate the carousel 20 in order to position for optimum generation of electricity. The upper surface 24 of the carousel 20 may reside in a plane that is generally vertical or horizontal, and may be configured to be adjustable to tilt to other desired angles/positions for optimal electrical efficiency or output. The elliptically-shaped solar panels 27a-f may be mounted on the upper surface 24 of the carousel 20 having equidistant spacing between each consecutive radial elliptically-shaped solar panel 27. Planar solar panels 26 may optionally be mounted or positioned in-between consecutive elliptically-shaped solar panels 27-a-f.

While the embodiments are described with reference to various implementations and exploitations, it will be understood that these embodiments are illustrative and that the scope of the inventive subject matter is not limited to them. Many variations, modifications, additions, and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A solar panel apparatus, comprising:
a solar panel cylinder having a length and a cross-section;
wherein the solar panel cylinder has an elliptically-shaped cross-section;
wherein the elliptically-shaped cross-section is defined by an equation xⁿ/aⁿ+yⁿ/bⁿ=1;
wherein the value of n is greater than or equal to 2; and
wherein a and b are any positive numbers.

2. The apparatus according to claim 1, further comprising:
a plurality of vertical rotatable rods, wherein the solar panel cylinder comprises a plurality of solar panel cylinders each mounted vertically to one each of the plurality of vertical rotatable rods;
a meter connected to each of the plurality of solar panel cylinders for detecting and measuring an electrical power output; and
wherein the plurality of rotatable rods are configured for rotating to a corresponding turning angle for achieving a peak value of the electrical power output.

3. The apparatus according to claim 1, further comprising:
a rotatable carousel having an upper surface, wherein the solar panel cylinder comprises a plurality of solar panel cylinders mounted on the upper surface of the rotatable carousel; and
a union joining each of the plurality of solar panel cylinders at one end.

4. The apparatus according to claim 1, further comprising:
a rotatable carousel having an upper surface, wherein the solar panel cylinder comprises a plurality of elliptically-shaped solar panels mounted on the upper surface of the rotatable carousel; and
a union joining each of the plurality of elliptically-shaped solar panels.

5. The apparatus according to claim 4, further comprising:
a meter connected to the plurality of elliptically-shaped solar panels for detecting and measuring an electrical power output; and
wherein the rotatable carousel is configured for rotating to a corresponding turning angle for achieving a peak value of an electrical power output.

6. The apparatus according to claim 1, further comprising:
a carousel having an upper surface, wherein the solar panel cylinder comprises a plurality of elliptically-shaped solar panels mounted on the upper surface of the carousel; and
a union joining each of the plurality of elliptically-shaped solar panels.

7. The apparatus according to claim 1, a plurality of vertical rotatable rods, wherein the solar panel cylinder comprises a plurality of solar panel cylinders each mounted vertically to one each of the plurality of vertical rotatable rods; and
wherein the apparatus uses a methodology, comprising the steps of:
rotating the vertical rotatable rods each about a respective axis;
determining a value of an electrical power output of the plurality of solar panel cylinders;
detecting a peak in the value of the electrical power output of the plurality of solar panel cylinders at a corresponding turning angle of the respective vertical rotatable rods; and
rotating the vertical rotatable rods to the corresponding turning angle until another peak value of the electrical power output is detected at another corresponding turning angle.

8. A method for installing a solar panel array, comprising the steps of:
mounting a solar panel to a frame;
mounting the frame vertically to a vertical rotatable rod;
rotating the vertical rotatable rod about an axis;
determining a value of an electrical power output of the frame;
detecting a peak in the value of the electrical power output of the frame at a corresponding turning angle of the vertical rotatable rod; and
rotating the vertical rotatable rod to the corresponding turning angle until another peak value of the electrical power output is detected at another corresponding turning angle.

9. The method for installing a solar panel array according to claim 8, wherein the step of rotating the vertical rotatable rod about the axis is performed quickly for determining the angle of maximum power output. The panels are then rotated to such angle followed by a slow rotation with increasing and decreasing angles alternatively to find the instantaneous optimum operational angles.

10. The method for installing a solar panel array according to claim 8, wherein a plurality of frames are respectively mounted vertically to a plurality of vertical rotatable rods; and wherein the step of determining the value of the electrical power output is performed collectively from the plurality of frames.

11. A method for installing a solar panel array, comprising the steps of:
mounting a plurality of solar panels to a frame;
mounting the frame vertically to a vertical rotatable rod;
turning the rotatable rod about an axis;
measuring the electrical power output of the plurality of solar panels with a meter;
detecting a peak electrical power output of the plurality of solar panels at a corresponding turning angle of the vertical rotatable rod; and
turning the vertical rotatable rod to the corresponding turning angle.
